(19) United States
(12) Patent Application Publication
(10) Pub. No.: US 2012/0012404 A1
(43) Pub. Date: Jan. 19, 2012

(54) LOW POWER, AUTOMATED WEIGHT LOGGER

(76) Inventors: John F. Cavanaugh, Ellicott City, MD (US); Wayne E. Esaias, Highland, MD (US)

(21) Appl. No.: 12/838,963

(22) Filed: Jul. 19, 2010

(51) Int. Cl. G01G 23/42; G01G 9/00

(52) U.S. Cl. 177/1; 177/2

(57) ABSTRACT

A low-power, automated weight logger may include a weighing scale having an electronic load cell and a data logger having a memory and a battery power supply. An adapter circuit may be connected to the electronic load cell and the data logger. The adapter circuit may include a battery power supply, a switchable voltage regulator, and an amplifier. The data logger may switch the voltage regulator in the adapter circuit on and off. The amplifier may amplify a signal from the load cell and send the amplified signal to the data logger. The voltage regulator may regulate power from the power supply to the load cell.

### ORIGIN OF INVENTION

The invention described herein was made by employees of the United States Government, and may be manufactured and used by or for the Government for governmental purposes without the payment of any royalties thereon or therefore.

### FIELD OF THE INVENTION

The invention relates in general to devices for automatically recording weight and in particular to low power, automated data loggers for recording scale weights.

### BACKGROUND

Pollination, a complex interaction of plants and animals, may be mandatory for terrestrial ecosystems. The timing of major pollination periods may be changing due to climate change and land use change, as plant blooming dates respond to temperature and climate and floral composition. Synchronization between the plants and pollinators must be maintained for healthy ecosystem function. This coupling between the plants and pollinators is extremely difficult to investigate due to the large numbers of species involved. The interaction may occur at varying times throughout the year, depending on location and the floral composition.

The advantages of using beehive weight changes for research are several. Compared to recording blooming dates from individual plants or small plots, the behavior of the bees integrates the information over a considerable area (for example, 5 km diameter). Bees also sample many species of plants. The area resolved by the hive sampling may be of the same spatial extent as derived satellite data (5 km binned resolution) and of coupled climate-ecosystem models. Bees may be kept in standard hives by about 100,000 beekeepers across the country.

Linkage between satellite derived vegetation phenology data and the period of plant-pollinator interaction may be quantified by monitoring weight changes of honey bee hives. There is a need for a low cost way to monitor the weight of hundreds of bee hives daily, at their remote locations. The weights of bee hives near residences are commonly monitored with manual beam balance platform scales. However, remote bee hive sites may only be visited at weekly, monthly, or even longer intervals.

A need exists for a low cost, low power, battery-powered logging scale for beehives. Low cost is important to encourage volunteer beekeepers to perform the monitoring at many sites across the country. If a low cost, low power, battery-powered logging scale for beehives were available, ecologists may be able to bring the vast sampling benefits of the satellite data to bear on this important research area.

### SUMMARY

It is an object of the invention to provide a low cost, low power, automated scale logger.

In one aspect, an automated weight logger may include a weighing scale having an electronic load cell, a data logger having a memory and a battery power supply, and an adapter circuit connected to the electronic load cell and the data logger. The adapter circuit may include a second battery power supply, a switchable voltage regulator, and an amplifier. The data logger may switch the voltage regulator in the adapter circuit on and off. The amplifier may amplify a signal from the load cell and send the amplified signal to the data logger. The voltage regulator may regulate power from the power supply to the load cell.

In one embodiment, the weighing scale may include a mechanical beam platform scale. The mechanical beam platform scale may have a weighing platform, a balance beam, and a tension rod connected between the weighing platform and the balance beam. The tension rod may include the electronic load cell.

In an alternative embodiment, the weighing scale may include a base and a loading platform. The electronic load cell may be disposed between the base and the loading platform. The loading platform may receive a weight to be measured.

Another aspect of the invention is a method that may include providing an automated weight logger, placing a beehive on the weighing scale, and intermittently recording a weight of the beehive.

The invention will be better understood, and further objects, features, and advantages thereof will become more apparent from the following description of the preferred embodiments, taken in conjunction with the accompanying drawings.

### BRIEF DESCRIPTION OF THE DRAWINGS

In the drawings, which are not necessarily to scale, like or corresponding parts are denoted by like or corresponding reference numerals.

FIG. 1 is a schematic diagram of an embodiment of an automated weight logger.

FIG. 2 is a schematic diagram of a conventional platform mechanical beam scale.

FIG. 3 is a schematic diagram of a modified platform mechanical beam scale.

FIG. 4A is a perspective view of the base an alternate embodiment of a weighing scale.

FIG. 4B is a perspective view of the loading platform of the alternate embodiment of a weighing scale.

FIG. 4C is a side view of FIG. 4B.

FIG. 4D is a sectional view of the alternate embodiment of a weighing scale taken along the location of line 4D-4D in FIG. 4B.

FIG. 5 is a diagram of one embodiment of an adapter circuit for an automated weight logger.

FIG. 6 is a schematic diagram of a bee hive.

### DETAILED DESCRIPTION

An automated weight logger may be used to measure, among other things, beehive weight changes. Beehive weight changes may indicate nectar availability and nectar harvesting in the environment. NASA has developed a network (http://honeybeenet.gsfc.nasa.gov) for the collation and analysis of beehive data to investigate the impact of climate change and land use change on honey bees and plant-pollinator interactions. The hive weight data may be compared with satellite-derived vegetation phenology data.

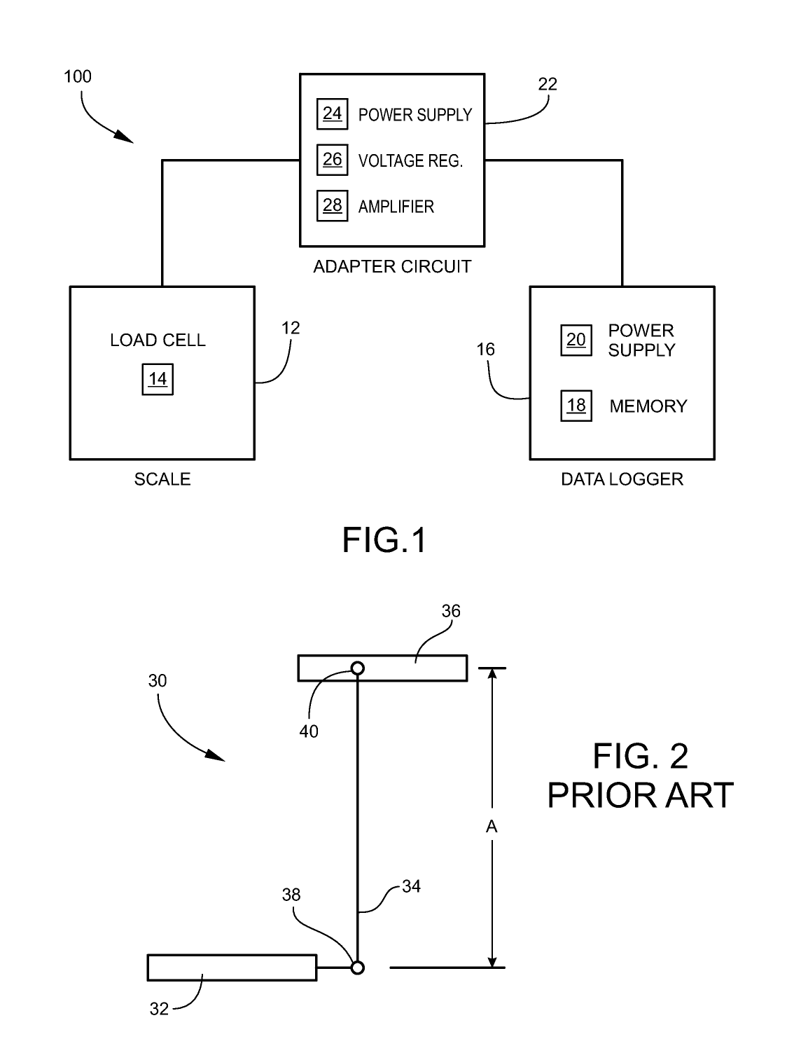

An embodiment of a low cost, low power, battery-powered, automated weight logger 100 is shown schematically in FIG. 1. The automated weight logger 100 may include a weighing scale 12, a data logger 16, and an adapter circuit 22 connected to the weighing scale 12 and the data logger 16. The weighing scale 12 may include an electronic load cell 14. The data logger 16 may include a memory 18 and a battery power supply 20. The adapter circuit 22 may include a battery power supply 24, a switchable voltage regulator 26, and an amplifier 28.

The data logger 16 may switch the voltage regulator 26 in the adapter circuit 22 on and off. The adapter circuit 22 may be connected to the electronic load cell 14. The amplifier 28 may amplify the signal from the load cell 14 and send the amplified signal to the data logger 16. The voltage regulator 26 may regulate power from the power supply 24 to the load cell 14. Load cell 14 may be a temperature compensated load cell.

The automated weight logger 100 may be used to measure the weight of a bee hive 90 (FIG. 6). The weight logger 100 may be disposed at the location of the bee hive 90, which may be a remote location. The bee hive 90 may rest on the weighing scale 12 continuously for long periods, such as a year or more.

FIG. 2 is a schematic diagram of a conventional platform mechanical beam scale 30. The conventional scale 30 may have a capacity of about 500 to about 100 pounds. The conventional scale 30 may include a weighing platform 32, a tension rod 34, and a beam balance 36. The tension rod 34 may have a length A. An item to be weighed is placed on platform 32. Platform 32 may have a lever ratio of about 15:1, for example. The lever system in the platform 32 may apply a force to the lower end 38 of tension rod 34. Tension rod 34 may transmit this force to beam balance 36 through the tension rod upper end 40.

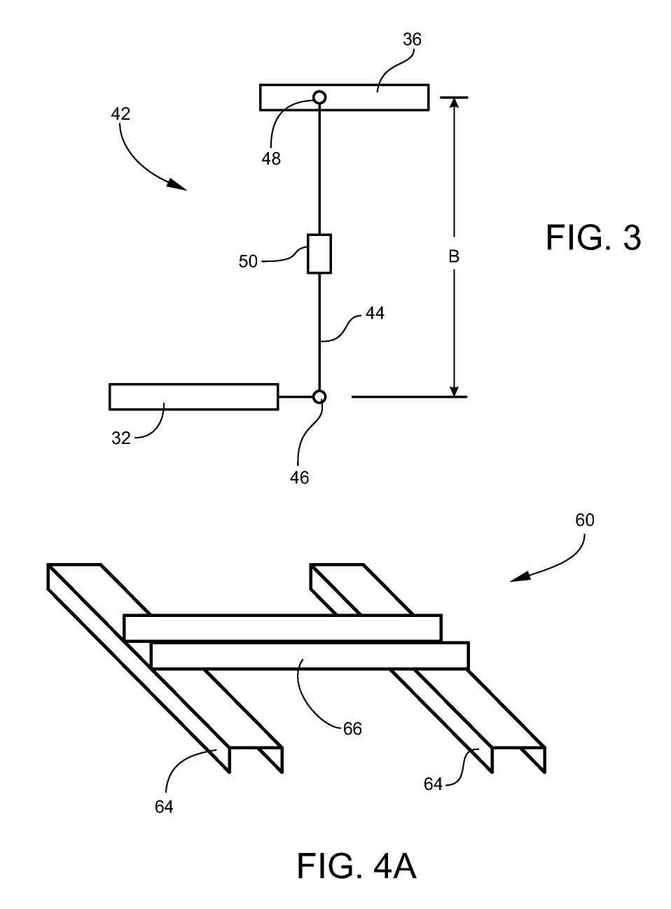

FIG. 3 is a schematic diagram of a modified platform mechanical beam scale 42. The modified scale 42 may include the platform 32, a tension rod 44, and the beam balance 36. The tension rod 44 may include an electronic load cell 50 disposed between its lower and upper ends 46, 48. The length B of tension rod 44 is the same as the length A of tension rod 34. Load cell 50 may provide an electric signal that is proportional to the weight of the item (not shown) on the platform 32. The item that is weighed may be a bee hive that remains in place on the platform 32 continuously.

Load cell 50 may be, for example, a tension-type load cell. The load cell 50 of FIG. 3 may correspond to the load cell 14 of FIG. 1. The mechanical advantage of the lever system in the platform 32 may be about 15:1. Thus, a load cell 50 having a 50 pound capacity and used with a 15:1 mechanical advantage lever system may have a weighing capacity of about 750 pounds. An example of a suitable load cell 50 is load cell Model FT24-3-1 available from Measurement Specialties, Inc.

The use of modified platform mechanical beam scale 42 may not involve variable weight distribution problems, and may enable repeated calibration with test weights of only a pound or two. The precision of the scale 42 within the range of daily changes may be unaffected by temperature variations and time.

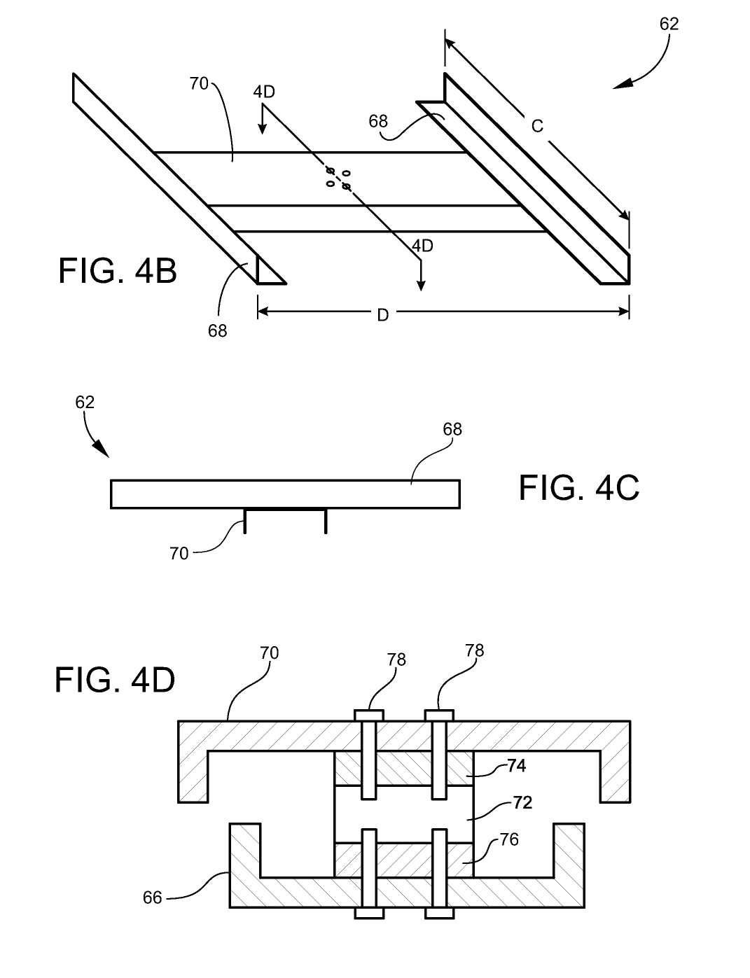

FIGS. 4A-D show an alternate embodiment of a weighing scale. FIG. 4A is a perspective view of the base 60 of the alternate embodiment of a weighing scale. Base 60 may include a pair of spaced-apart longitudinal supports 64 and a cross-member 66 fixed above the supports 64 about midway between the supports 64. Supports 64 and cross-member 66 may have, for example, channel-shaped cross-sections.

FIG. 4B is a perspective view of the loading platform 62 of the alternate embodiment of a weighing scale. FIG. 4C is a side view of FIG. 4B. Loading platform 62 may include a pair of longitudinal supports 68 and a cross-member 70 fixed beneath the supports 68 about midway between the supports 68. Supports 68 may have, for example, an L-shaped cross-section. Cross-member 68 may have, for example, a channel-shaped cross-section. For supporting a standard size bee hive, the supports 68 may have a length C of about 20 inches long and may be spaced apart a distance D of about 16.5 inches.

FIG. 4D is a sectional view of the alternate embodiment of a weighing scale taken through the cross-members 66, 70 and the electronic load cell 72, at the location of line 4D-4D of FIG. 4B. Note that FIG. 4B shows only the loading platform 62 while FIG. 4D is a section through both the base 60 and the loading platform 62. Spacers 76, 78 may be placed above and below load cell 72 to allow load cell 72 to deform, while preventing contact between cross-members 66, 70. Load cell 72 may be fixed to spacers 76, 78 and cross-members 66, 70 using, for example, threaded fasteners 78. Base 60 and loading platform 62 may be made of, for example, aluminum.

Load cell 72 may be, for example, a single-point compression or bending beam load cell. The load cell 72 of FIG. 4D may correspond to the load cell 14 of FIG. 1. Calibration of load cell 72 may require up to 150 pounds of test weights.

Data logger 16 (FIG. 1) may include a low-power battery supply 20, for example, a 3 volt lithium battery, and a digital memory. A suitable data logger 16 may be a 12 bit data logger Model U12-013 available from ONSET Computer. Data logger 16 may include an external temperature probe and may accept 2 external inputs.

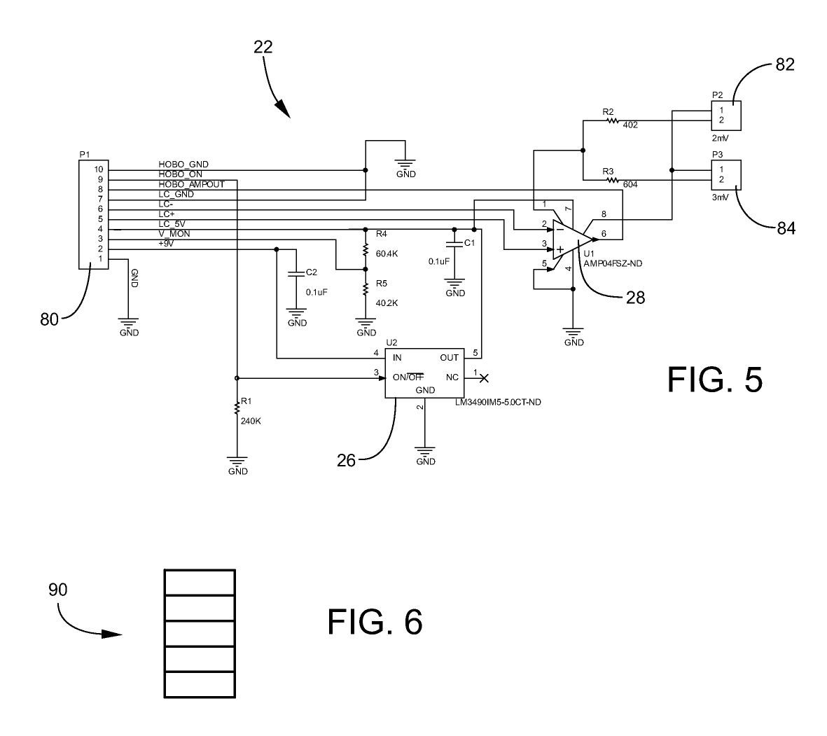

The adapter circuit 22 (FIG. 1) may be connected to the data logger 16 and the load cell 14. The adapter circuit 22 may include a battery power supply 24, a switchable voltage regulator 26, and an amplifier 28. FIG. 5 is an example of a circuit diagram for adapter circuit 22. Connection block 80 contains connections 1-10 for circuit 22. The battery power supply 24 (FIG. 1), for example, a 9 volt battery, may be connected to voltage regulator 26 via connections 1 and 2 of connection block 80. Voltage regulator 26 may be, for example, a 5 volt linear switchable regulator. Voltage regulator 26 may be switched on and off by the data logger 16 via connection 9 of connection block 80. Power from the power supply 24 (FIG. 1) may be supplied by the voltage regulator 26 to the load cell 14 via connections 4 and 7 of connection block 80. A voltage monitoring signal may be supplied to data logger 16 via connection 3 of connection block 80.

The weight signal from load cell 14 may be supplied to amplifier 28 via connections 5 and 6 of connection block 80. The amplifier 28 may amplify the load cell signal to about 5 volts, and supply the amplified signal to the data logger 16 via connection 8 of connection block 80. Because the sensitivity of load cells may vary, a jumper circuit including an additional pair of connection blocks 82, 84 may be provided. For example, if a load cell has a sensitivity of 2 mV/V, then a jumper cable may be placed between the two connections in block 82. If the load cell sensitivity is 3 mV/V, then a jumper cable may be placed between the two connections in block 84.

The voltage regulator 26 may respond to a signal from the data logger 16 to thereby provide power to the load cell 14. The data logger sample time may be less than a second. The data stored in the memory 18 of the data logger 16 may be downloaded via a USB connection to, for example, a laptop computer. Because the automated weight logger 100 may be remotely located, low power consumption and the conservation of power are important.

Weight readings may be taken every ten minutes to resolve the daily temperature excursions and daily bee hive weight change. The memory 18 in the data logger 16 may be sufficient for two months of unattended operation. At this duty cycle, both the 3 volt data logger battery 20, for example, and the 9 volt circuit board battery 24, for example, may last over a year. The bee hive may sit continuously on the weighing scale 12. Scale measurements may be made at daily intervals throughout the year. During active hive periods, daily weight changes of a hive may be monitored to within about 0.5 pound or less. A daily change of bee hive weight may be in a range from about −5 to about +30 pounds. The total hive weight may range between about 50 and about 500 pounds. During less active periods, such as winter, the hive weight may be measured at least weekly. The required precision may be about 0.1%. The ambient temperature may also be logged.

There may be many other uses for a low-power, remote logger for weight or strain. The prior art may be devoid of a low cost, low power data logger for load cell measurements. Prior art devices may cost several thousands of dollars, may require large batteries, may use alternating current, or may require a dedicated computer. The invention may be useful where many spatially remote sites must be monitored. Examples may include measurement of bridge and building stresses, and snow “pillow” pack monitoring.

While the invention has been described with reference to certain preferred embodiments, numerous changes, alterations and modifications to the described embodiments are possible without departing from the spirit and scope of the invention as defined in the appended claims, and equivalents thereof.

What is claimed is:

1. An automated weight logger, comprising:
a weighing scale having an electronic load cell;
a data logger having a memory and a battery power supply; and
an adapter circuit connected to the electronic load cell and the data logger, the adapter circuit including a second battery power supply, a switchable voltage regulator, and an amplifier;
wherein the data logger switches the voltage regulator in the adapter circuit on and off, the amplifier amplifies a signal from the load cell and sends the amplified signal to the data logger, and the voltage regulator regulates power from the power supply to the load cell.

2. The automated weight logger of claim 1, wherein the weighing scale comprises a mechanical beam platform scale having a weighing platform, a balance beam, and a tension rod connected between the weighing platform and the balance beam, the tension rod including the electronic load cell.

3. The automated weight logger of claim 1, wherein the weighing scale comprises a base and a loading platform and the electronic load cell is disposed between the base and the loading platform and further wherein the loading platform receives a weight to be measured.

4. The automated weight logger of claim 4, wherein the base comprises a pair of longitudinal supports and a cross-member disposed about midway between the longitudinal supports and the loading platform comprises a second pair of longitudinal supports and a second cross-member disposed about midway between the second pair of longitudinal supports and further wherein the electronic load cell is disposed between the cross-member and the second cross-member.

5. The automated weight logger of claim 1, wherein a capacity of the weighing scale is at least 500 pounds.

6. The automated weight logger of claim 1, wherein the data logger battery power supply is less than about 5 volts and the adapter circuit second battery power supply is less than about 10 volts.

7. The automated weight logger of claim 1, further comprising a bee hive disposed on the weighing scale.

8. The automated weight logger of claim 1, wherein the load cell is a temperature-compensated load cell.

9. The automated weight logger of claim 2, wherein the mechanical beam platform scale is a conventional mechanical beam platform scale and the tension rod and electronic load cell are substituted for a conventional tension rod.

10. A method, comprising:
providing the apparatus of claim 1;
placing a beehive on the weighing scale; and
intermittently recording a weight of the beehive.

11. The method of claim 10, wherein placing the bee hive includes placing the bee hive continuously on the weighing scale for at least one week.

12. The method of claim 11, wherein placing the bee hive includes placing the bee hive continuously on the weighing scale for at least three months.

13. The method of claim 10, wherein intermittently recording the weight includes recording the weight at least weekly.

14. The method of claim 13, wherein intermittently recording the weight includes recording the weight at least daily.

15. The method of claim 14, wherein intermittently recording the weight includes recording the weight at least multiple times per day.

16. The method of claim 10, wherein intermittently recording the weight includes recording the weight in a digital memory.

17. The method of claim 10, further comprising using the voltage regulator to intermittently supply about five volts to the electronic load cell.
